(19) United States
(12) Patent Application Publication
(10) Pub. No.: US 2013/0078025 A1
(43) Pub. Date: Mar. 28, 2013

(54) REFILL SYSTEM AND METHOD

(71) Applicants: Carmit Turgeman, Tel-Aviv (IL); Yi Ming Hui, Tai Tam (HK)

(72) Inventors: Carmit Turgeman, Tel-Aviv (IL); Yi Ming Hui, Tai Tam (HK)

(21) Appl. No.: 13/638,190

(22) PCT Filed: Mar. 31, 2011
(86) PCT No.: PCT/IL2011/000285

§ 371 Date: Dec. 10, 2012

Related U.S. Application Data
(60) Provisional application No. 61/319,269, filed on Mar. 31, 2010.
(60) Provisional application No. 61/319,270, filed on Mar. 31, 2010.

(51) Int. Cl. B43K 5/18

(52) U.S. Cl. CPC B43K 5/18
USPC 401/258

(57) ABSTRACT

A portable refillable marker-fluid cartridge comprising a marker-chamber, a marker-fluid applicator extending from out of the cartridge wherein the marker fluid applicator is in fluid communication with the marker-chamber, a filling mechanism configured to open from a delivery tube being pushed theretowards, thereby allowing the marker fluid to pass into the marker-chamber, and at least one seal-ring configured to minimize leak of the marker-fluid out of the marker-chamber.

### FIELD OF THE INVENTION

The present invention relates to refillable markers. In particular, the invention relates to systems and methods for filling refillable marker-fluid cartridges from fillers of marker-fluid.

### BACKGROUND

Markers such as pens, paint brushes, printers and the like are used to leave recordable traces upon surfaces. Typically, the recordable traces are left by the application of a marker-fluid, such as paint, an ink or the like onto the surface.

Traditional chalk for blackboards is messy and white board pens have gradually replaced the chalk. However, when the ink is used up the entire pen can only be discarded, causing a great waste of resources and environmental pollution, but also greatly increasing the cost of the pen. CN96202527 to Qiu Jinsheng describes a model for an automatic ink-suction erasable whiteboard pen. However, it is not leak-proofed and thus is messy and wasteful, both from ink spillage and ink evaporation.

The amount of marker-fluid carried by the marker is limited and therefore, as marker-fluid is applied to the surface, the supply of marker-fluid in the marker is periodically exhausted. When insufficient marker-fluid remains in the marker, the marker-fluid supply must be replenished or the marker must be thrown away.

By their nature, marker-fluids are generally pigmented and free flowing. Accordingly, the refilling of markers is typically a messy process. For convenience, therefore, disposable markers are most popular. However it will be appreciated that frequently disposing of markers is wasteful and costly.

Some printer cartridges, such as inkjet cartridges, may be refillable. Typically, this is done by filling a syringe with ink, removing a cover from an ink cartridge presumed to be empty, and injecting printer ink from the syringe via a syringe needle fitted on the syringe, through a septum in the cartridge into the cartridge. Refilling is performed until the ink starts to bubble out of the septum. Such filling does require some dexterity, prior knowledge of the structure of the cartridge, and time and effort to perform. Thus typically it is performed at a factory dedicated for refilling.

U.S. Pat. No. 4,473,097 to Seaguist Valve Company describes an apparatus for receiving and measuring a quantity of fluid from a filling device comprising a container having a substantially flat container bottom for resting on a horizontal surface. The container is preferably flexible, to allow an operator to press the container to discharge fluid in the form of a sprinkle from the dispensing orifice, and has a translucent sidewall with markings disposed on the sidewall enabling an operator to determine the quantity of fluid therein by viewing the fluid level in the container relative to the markings. A sealing valve is disposed proximate the container bottom and adapted to receive fluid from the filling device enabling the container to be filled to a desired fluid level from the fluid filling device. A dispensing orifice is in fluid communication with the interior of the container for dispensing fluid therefrom. The bottom portion of the bottle is a detachable container base having several walls: an outer sidewall, an inner sidewall, and a lip that forms flat bottom. Moreover, container means is provided with an opening in the bottom portion that is sealed by another wall of the base when the base is attached to the container. The base is threaded to the container by threads of the container wall and a thread of the inner sidewall. The sealing valve is deflected by pressure of the propellant fluid.

US 20090194191 to C.T.I describes a refill bottle adapted to repeatedly receive and dispense liquids such as perfume. The refill bottle includes a bottle having a bottom portion and an upper portion, an opening provided in the upper portion wherein the opening is adapted to be covered, and a refill mechanism provided in the bottom portion. The liquid is received through the refill mechanism from a regular bottle, for example via a spraying mechanism, and is dispensed through the opening.

The regular bottle is for example a regular spray bottle, and the spray mechanism includes for example a stem. The refill mechanism includes for example a check valve that is adapted to open when a stem is pushed through a bottom opening provided in the bottom portion, the stem pushing open the valve, and the liquid is pushed inside the refill bottle through the stem.

Chinese utility model ZL 200720051806.9 to Dongguan YiXin Magnetic describes a portable and refillable spraying bottle which can be reused after refilling. The bottle includes a nozzle assembly, an inner bottle and housing, the nozzle assembly installed on the top of the inner bottle. In the bottom of said inner bottle installed a refilling construction. Said refilling construction consists of a refill inlet in the bottom of said inner bottle, an abutting rod installed in said refill inlet, a restoration construction for said abutting rod and sealing construction. Said inner bottle is further equipped with an exhaust construction.

It should be appreciated that leakage of liquids such as perfume, while wasteful, typically is harmless; whereas leakage of marking fluids such as ink from a marker-fluid or a refill bottle must be avoided. In addition, bottles for refilling marking fluids are not available, as there was no recognized need for such.

There is a need for a clean, efficient, sealable, environment-friendly, and convenient system and method for refilling marking-fluid cartridges such as markers. Embodiments disclosed herein address this need.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

In the accompanying drawings:

FIG. 1a depicts a section through a refillable marker-pen in some embodiments of a system for filling marker-fluid cartridges;

FIG. 1b is an exploded view of the bottom portion of the marker-fluid cartridge shown in FIG. 1a;

FIG. 2 is a schematic representation of an ink-filler including an a delivery mechanism in embodiments of system for filling marker-fluid cartridges, the ink-filler suitable for use with marker-fluid cartridges such as shown in FIG. 1a;

FIG. 3a is a representation of a system including the bottom portion of the cartridge of FIG. 1a together with an ink-filler;

FIG. 3b shows the system depicted in FIG. 3a, showing filling of the cartridge with the filler;

FIG. 4a is a cross-sectional representation of a cartridge in other embodiments;

FIG. 4b is an exploded view of the bottom portion of the marker-pen shown in FIG. 4a;

FIG. 4c is an exploded view of an air release valve in a marker-pen in some embodiments;

FIG. 4d is an exploded view of an air release valve in a marker-pen in some other embodiments;

FIG. 5a is a cross-sectional representation of a cartridge in yet some more embodiments;

FIG. 5b is an exploded view of the bottom portion of the marker-fluid cartridge shown in FIG. 5a;

FIG. 6 is a schematic representation of a refillable ink-cartridge for use in a computer printer according to still another embodiment;

FIG. 7 is a schematic representation of a presentation board incorporating a marker refilling station including a plurality of ink-fillers, and

FIG. 8 is a flowchart showing the main steps of a method for filling a marker-fluid cartridge according to another embodiment of the invention.

### SUMMARY OF THE INVENTION

According to one aspect, a system for filling marker-fluid cartridges comprises:
a) at least one marker-fluid filler comprising:
a reservoir;
a delivery tube through which the marker-fluid is dispensable, and
a pump configured to allow pumping said marker-fluid in said reservoir throughout the delivery tube, and
b) at least one portable refillable marker-fluid cartridge configured to allow receiving the marker-fluid from said at least one marker-fluid filler, each cartridge comprising:
a marker-chamber therein;
a marker-fluid applicator extending from out of the cartridge wherein said marker fluid applicator is in fluid communication with the marker-chamber;
a filling mechanism configured to open from the delivery tube being pushed theretowards, thereby allowing the marker fluid to pass into the marker-chamber, and
at least one seal-ring configured to minimize leak of the marker-fluid out of the marker-chamber.

The system of claim may have a cartridge with a wall comprising an
invagination therein, wherein the filling mechanism is held in said invagination.

According to another aspect, a portable refillable marker-fluid cartridge is provided, comprising:
a marker-chamber therein;
a marker-fluid applicator extending from out of the cartridge wherein said marker fluid applicator is in fluid communication with the marker-chamber;
a filling mechanism configured to open from a delivery tube being pushed theretowards, thereby allowing the marker fluid to pass into the marker-chamber, and at least one seal-ring configured to minimize leak of the marker-fluid out of the marker-chamber.

The cartridge may comprise a wall comprising an invagination therein, wherein the filling mechanism is held in said invagination.

Pumping said marker-fluid in said filler may be achievable by intermittently and repeatedly pushing the delivery tube against the filling mechanism.

Preferably, the cartridge further comprises air-release means configured to allow expelling air from the marker-chamber during filling the marker-chamber with marker-fluid, and to not allow expelling of marker-fluid from the marker-chamber.

In some embodiments, said marker-chamber comprises a marker-fluid absorbent fluidly communicable with both the filling mechanism and the applicator.

Preferably, when the applicator of the cartridge is applied to a surface, thereby applying marker-fluid to the surface, the absorbent and the marker-fluid of the cartridge allow replacement of the marker-fluid in the applicator at a rate faster than the rate the marker-fluid is applied to the surface.

The cartridge may further comprise a removable valve cap for the cartridge, configured to seal off the filling mechanism of the cartridge from air when the valve cap is fit onto the cartridge.

The marker-chamber preferably comprises in a wall thereof a transparent volume indication window indicative of the extent the marker-chamber is filled with the marker-fluid.

Some system embodiments further comprise at least one presentation board. Preferably in those embodiments, each filler is colour-coded to match each cartridge. Said marker-fluid applicator may be selected from a group consisting of: print heads, nibs, roller-balls, ball-points, felt-tips, fiber-tips, brushes, reeds, nozzles and combinations thereof.

The cartridge may be for example selected from one or more of the group comprising: pens, paint brushes, whiteboard markers, permanent markers and inkjet cartridges, highlighters, laser printer toner cartridges and correction fluid cartridges.

The marker-fluid may be selected for example from one or more of a group comprising: inks, paints, whiteners, thinners, solvents, dyes and combinations thereof. The marker-fluid may be selected from a group comprising: solutions, gels, suspensions and emulsions.

According to another aspect, a method for filling a marker-fluid cartridge is provided, the method comprising:
providing a filler of marker-fluid, the filler comprising:
a delivery tube through which the marker-fluid is dispensable, and
a pump;
providing a portable refillable marker-fluid cartridge comprising:
a marker-chamber therein; a filling mechanism, and a seal-ring, the filling mechanism configured to open from a delivery tube being pushed thereto, the seal-ring configured to minimize leak of the marker-fluid out of the marker-chamber;
coupling said delivery tube to the filling mechanism; and

drawing marker-fluid with said pump from said filler into said marker-chamber via said filling mechanism, while preventing release of marker-fluid from said marker-chamber.

coupling said delivery tube to said filling mechanism and drawing said marker-fluid may comprise: repeatedly pushing said delivery tube against the filling mechanism such that said filling mechanism opens to allow the marker-chamber to receive said marker fluid.

The filling mechanism may comprise a holder with a channel passing therethrough, slideable and held with at least one seal-ring in the invagination.

The channel may have an internal diameter adjacent to the wall comprising the invangination, the diameter allowing a close fit of the delivery tube therein.

The filling mechanism may further comprise a filling port leading from the wall to the channel.

The filling port may allow a close fit of the delivery tube therein.

The cartridge may further comprising a removable cap, configured to seal off the applicator from air when the cap is fit onto the cartridge.

The filling mechanism may comprise a piston comprising a bottom pliable and resilient part and a top hard part permanently attached thereto, the top part being pushed up by the bottom part, the pliable and resilient part, when not forced by a tube, sealing the chamber; when forced by a tube, the force of the tube compresses the bottom part whereby marker fluid may enter the chamber via at least one gap between the piston and the invagination.

The invagination comprises at least one tooth to hold the piston.

The marker-fluid applicator may comprise a feeder shaft within the chamber, wherein the feeder shaft comprises a resilient material that urges the piston down and can be sufficiently compressed by the piston when the piston is pushed by a tube upwards to allow filling the cartridge with the marker-fluid.

### DESCRIPTION OF THE PREFERRED EMBODIMENTS

Embodiments described herein are directed towards providing a refill system for conveniently supplying a marker or other marking utensil with marker-fluid. The refill system may be used with a variety of marker-fluid cartridges, such as pens, ink-jet cartridges, toner cartridges and the like, a selection of which are described in the embodiments below, for illustrative purposes only. It will be appreciated that other embodiments of refill system may be used to fill other markers with further marker-fluids as required.

Reference is now made to FIG. la which shows a section through a refillable marker-fluid cartridge 100 according to a first embodiment of the refill system.

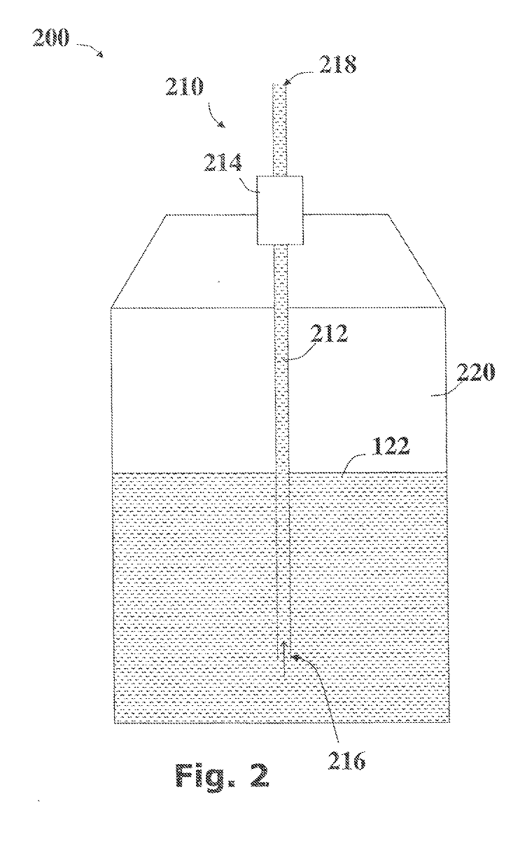

The marker-fluid cartridge 100 includes an ink-chamber 120, an ink-applicator 140 in an upper portion 101 and a filling mechanism 110 in a bottom portion 102. The filling mechanism 110 in this embodiment is essentially a check valve. The bottom part has a bottom wall 125 with an invagination 128, forming a space (see FIG. 2) in which the filling mechanism 110 is held, as will be further explained and shown below.

The ink-chamber 120 is provided to contain a supply of marker-fluid 122. The marker-fluid 122 is typically a pigment or dye based fluid such as ink, paint or the like, and is alternatively simply and collectively referred to below as ink. As required, the pigmented fluid may be a solution, suspension, emulsion, a gel, an aerosol or the like. It will be appreciated that according to various embodiments, the marker-fluid chambers, such as the ink-chamber 120 may be configured to contain alternative or additional materials, such as thinners, cleaning agents, whiteners, ink eradicators, solvents and the like.

The marker-fluid cartridge 100 typically has the dimensions of commercially available typical marker-pens. In particular, the size of the ink-chamber 120 is typically limited by the nature of use of the marker-fluid cartridge 100. Because the marker-fluid cartridge 100 is generally a hand-held device which a user must manipulate with considerable dexterity, a bulky and heavy ink-chamber would be inappropriate. An aspect of embodiments of the refill system is to provide an auxiliary supply of marker-fluid which does not impede normal usage of the marker-fluid cartridge 100.

The ink-applicator 140 is provided to apply the marker-fluid 122 to a surface. The applicator 140 of the refillable marker-fluid cartridge 100 of the first embodiment includes a fiber-tip nib 142 which is in fluid communication with the supply of marker-fluid 122 via a feeder-shaft 144 in the ink-chamber 120. The fiber-tip nib 142 and feeder-shaft 144 typically include a porous and/or fibrous marker-fluid absorbent material 123 such as felt, nylon or the like such that marker-fluid 122 is drawn up the feeder-shaft 144 by capillary action to the fiber-tip nib 142. A suitable removable cap 130 is provided to protect the nib 142 while not in use and to prevent unnecessary loss of ink 122 by fitting onto the upper part 101.

It will be appreciated that, although a fiber-tip nib 142 is presented in the above described embodiment, alternative marker-fluid applicators, such as nibs, roller-balls, ball-points, brushes and the like, may be preferred.

The applicator 140 is configured to apply marker-fluid 122, stored in the ink-chamber 120, to surfaces (not shown). As marker-fluid 122 is drawn from the ink chamber 120, the supply of marker-fluid 122 within the ink-chamber 120 is periodically exhausted during use. In contradistinction to prior art disposable markers, it is a particular feature of embodiments of the refill system herein disclosed that the marker-fluid cartridge such as the marker-fluid cartridge 100 includes a filling mechanism 110 configured to enable the supply of marker-fluid to be replenished when necessary.

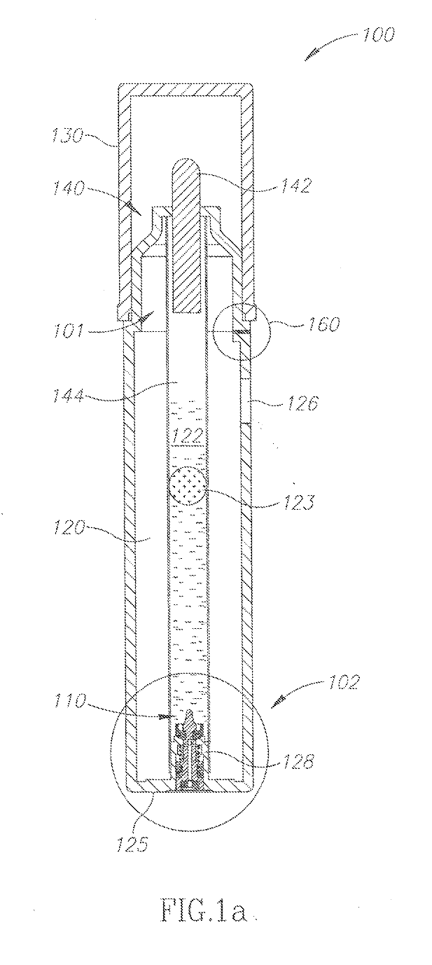

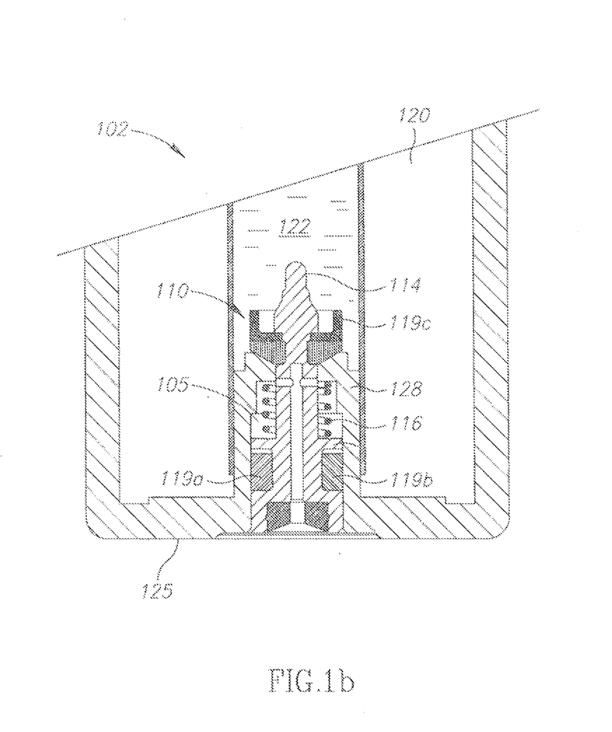

As shown in FIG. 1b, a holder 114, assembled together with a flexible seal-ring 119b such as an O-ring, and a spring 116, may be inserted into the invagination 128. Sealing ring 119a may then be installed onto the holder 114 to complete a filling port 127. A further seal 119c may then be installed onto the holder 114 to complete the filling mechanism 110.

The sealing ring 119c is conical at its bottom surface and top surface, on the top surface to fit the top of the holder 114, which is formed in the shape of a restricting block with a conical lower portion, and on the bottom surface to fit the upper portion of said invagination 128, which is also conical.

There is a channel 112 in a holder 114, that extends to a bottom wall 125, or to the filling port 127. The channel 112 provides a conduit through which ink marker-fluid 122 may be introduced into the ink-chamber 120. The channel 112 may have either a diameter 113 adjacent to the bottom wall 125 allowing a close fit of a suitable delivery tube (not shown) therein, or the delivery tube has a larger diameter than the channel diameter 113, and filling port 127, which is preferably cylindrical, allows a close fit therein, so that during filling the cartridge 100 leakage of marker-fluid at the area of contact of the tube with the filling mechanism is minimal. The sealing ring 119a is preferably made of an elastomeric material, that the delivery tube tip is pushed against, or is inserted into.

In some embodiments, the filling mechanism is not disposed in the bottom wall, and may be held in a structure other than an invagination of a wall.

Reference is now made to FIG. 2 which is a schematic representation of an ink-filler 200 according to a second embodiment of the refill system.

Marker-fluid fillers, such as the ink-filler 200 are configured to supply marker-fluid, such as ink, paint, thinner or the like, into a marker-fluid cartridge, such as the refillable marker-fluid cartridge 100 of the first embodiment.

Referring to schematic FIG. 2, an ink-filler 200 includes a marker-fluid reservoir 220 and a delivery mechanism 210. The marker-fluid reservoir 220 provides an auxiliary supply of marker-fluid 122 which is normally larger than is convenient to store within a marker-fluid cartridge. The marker-fluid reservoir 220 may be used to replenish the marker-fluid 122 supply carried by the marker-pen 100 of the first embodiment, for example, such as required when the ink-chamber 120 is empty.

The marker fluid 122 may be drawn from the marker-fluid reservoir 220 by the delivery mechanism 210 which is configured to couple with the filling mechanism of a marker-fluid cartridge such as in the marker-fluid cartridge 100 described hereinabove in relation to FIG. 1a.

The delivery mechanism 210 of the ink-filler 200 comprises a delivery tube 212 and a pump 214. The delivery tube 212 is configured to provide a fluid communication between the marker-fluid reservoir 220 of the ink-filler 200 and the ink-chamber of the marker-fluid cartridge. Accordingly, the first end 216 of the delivery tube 212 is typically in fluid communication with the marker-fluid reservoir 220 and the second end 218 of the delivery tube 212 is configured to be introduced into the channel of the filling mechanism of the marker-fluid cartridge, to push against the filling mechanism and to open the filling mechanism as will be further shown and explained below. Alternative coupling methods may be used as required.

The pump 214 is configured to draw marker-fluid 122 through the delivery tube 212. Accordingly, when the ink-filler 200 is coupled to the marker-fluid cartridge ink or other marker-fluid 122 may be drawn from the reservoir 220 and into the ink-chamber 120. Typically the pump includes a springed mechanism or the like adapted to pump liquid. The pump has to be sufficiently powerful to allow pumping the typically viscous marker fluid 122 into the marker-chamber 120.

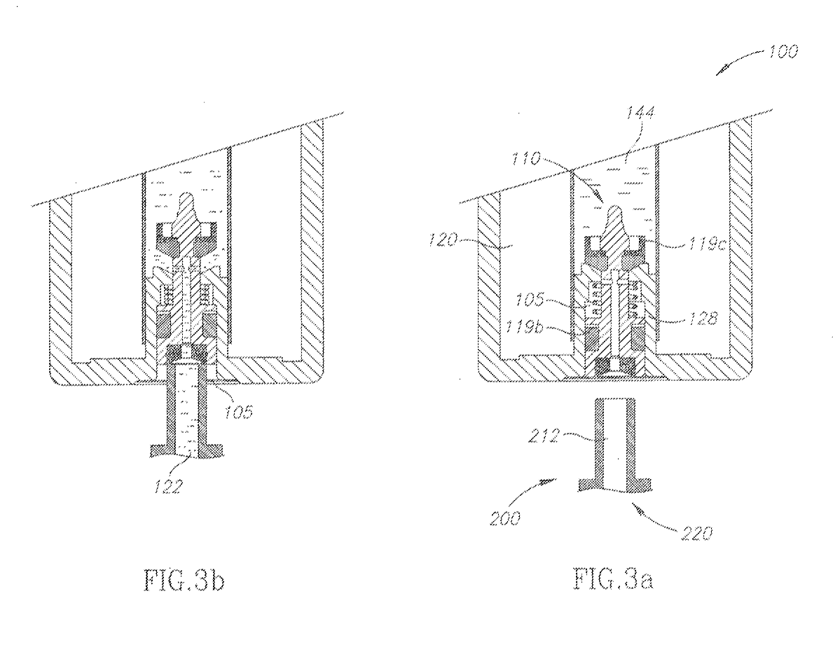

Referring to FIG. 3a, the holder 114 of the first embodiment is normally closed to prevent leakage of marker-fluid 122 from the ink-chamber 120. Spring 116 urges holder 114 down along the invagination 128, in the space 105. Seal 119c, also urged down, prevents marker-fluid entering from the feeder-shaft 144 into the space 105, and seal 119b provides an additional sealing against marker-fluid from the channel 112 or from the feeder-shaft 144.

As shown in FIG. 3b, pushing a suitably sized delivery tube 212 against the holder 114 causes the holder 114 to slide up in the invagination 128 together with the sealing rings 119a-c, and also a release of marker-fluid into the channel 112 and therefrom into the cartridge 100.

Referring back to FIG. 1a, marker-fluid cartridge 100 further comprises absorbent 123 in the ink-chamber 120, which preferably replenishes the marker-fluid 122 in the applicator 142 faster than it is applied to a surface.

The marker pen may also include a valve cap (not shown) to keep the filling mechanism 110 clean.

The marker-pen also includes means for release of air 160 to allow removal of air from the ink-chamber 120 during the filling of the ink-chamber 120.

A part of a wall of the ink-chamber 120 is a transparent window 126 to allow following the extent the marker-chamber 120 is filled with the marker-fluid 122.

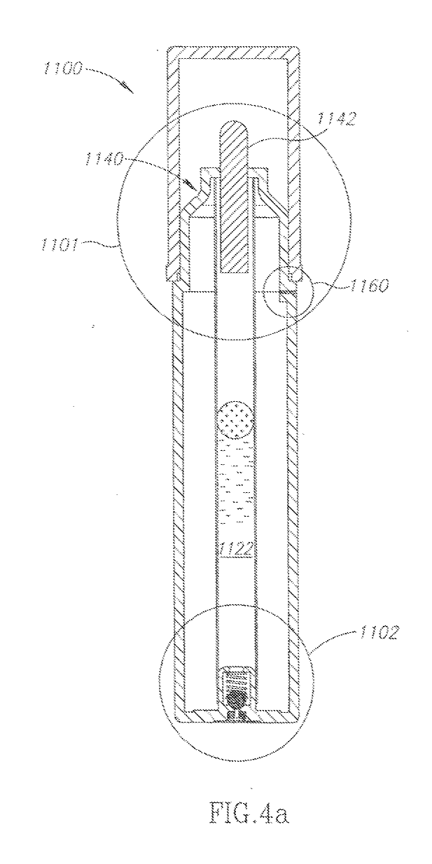

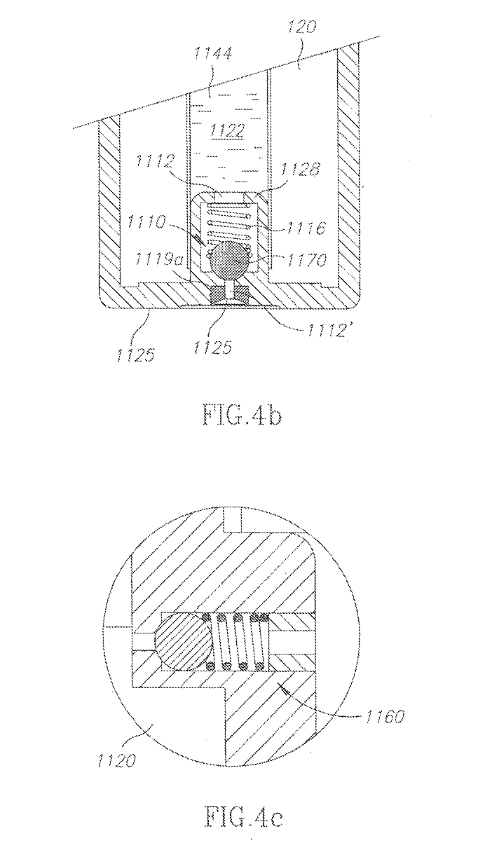

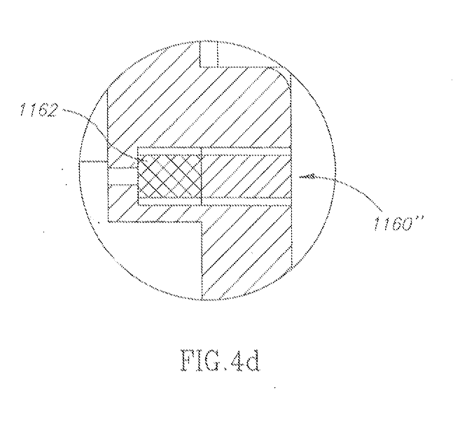

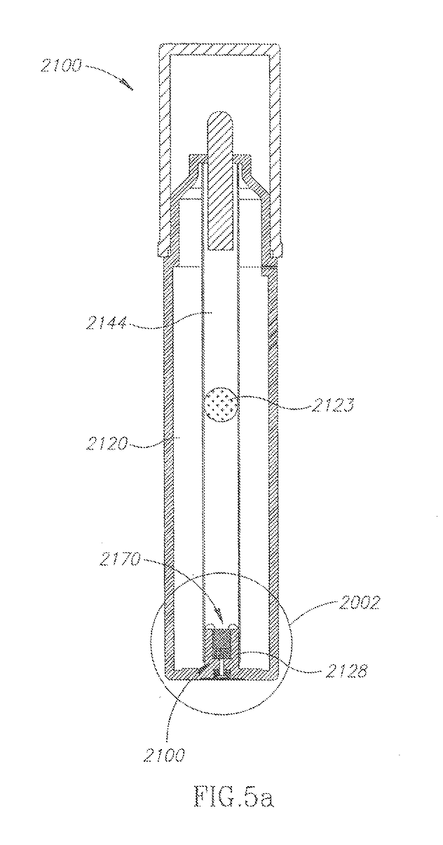

Reference is now made to FIG. 4a, showing an alternative marker-fluid cartridge 1100 for use in other embodiments of the refill system. The cartridge 1100 has an upper portion 1101 similar or identical to the upper portion 101 in the embodiment 100, but the bottom portion 1102 is different from the bottom portion 102, as clearly shown in exploded view in FIG. 4b.

The simple filling mechanism 1110 includes, similar to the embodiment shown in FIG. 1b, a port 1127, and a seal 1119a. The bottom wall 1125 similarly invaginates into the marker-fluid cartridge 1000; however the contours of the invagination 1128 are different to accommodate the different structure of the filling mechanism 1110. The mechanism 1110 itself includes a spring 1116 and ball 1170, preferably made of or coated with a material such as steel, which does not attract marker fluid 1122. The invagination 1128 is shaped at the top of the bottom channel 1112′, for example in conical shape, such that when the marker-fluid cartridge 1000 is not being filled, the spring 1116 urges the ball 1170 toward the bottom channel 1112′ and at least partially seals the channel 1112′. When filling the marker-fluid cartridge 1000, the ball 1170 is elevated, no longer blocking the lower channel 1112′ and lets the marker-fluid go throughout the lower channel 1112′ and then throughout the upper channel 1112″ and into the feeder-shaft 1144.

The supply of ink 122 in the ink-chamber 1120 is exhausted during use. Whenever necessary, the filling mechanism 1110 may be used to supply more ink into the ink-chamber 1120 of the cartridge 1100.

When the filling mechanism 1110 is not being forced by a tube, the seal 1119a may be compressed by the spring 1116 via smooth bead 1170, thereby further helping to seal the lower channel 1112′ off from the ink chamber 1120.

The applicator may be a ball-point, particularly suitable for use with viscous marker fluids as well as gels and the like. Accordingly, where necessary, ink-fillers may be provided with delivery mechanisms configured to dispense marker-fluids having a variety of fluid characteristics to suit requirements.

FIG. 4c shows an expanded illustration of an air release valve 1160′, similar in structure to the filling mechanism 1110. The valve 1160′ allows release of air from the ink-chamber 1120 during filling, thereby both facilitating the filling by lowering back-pressure in the cartridge 1100, and minimizing evaporation/oxidation of the marker-fluid. The valve also prevents entrance of atmospheric air therethrough.

Alternatively, the air release valve may have a different structure, such as a flap-valve 1160″ shown in FIG. 4d, that includes a flexing rubber diaphragm 1162 positioned to create a normally-closed valve.

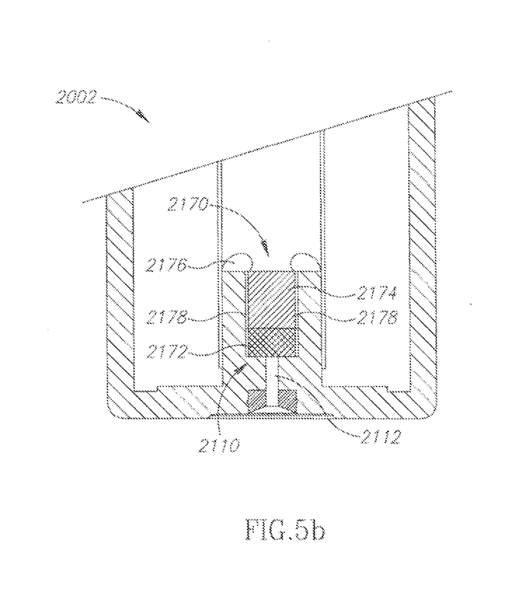

Yet another marker-fluid cartridge 2100 is shown in FIG. 5, in which the lower portion 2002 includes yet another kind of filling mechanism 2110, which includes a very simple piston 2170 including a bottom pliable and resilient part 2172 and a top hard part 2174 to which bottom part 2172 is permanently attached. There is at least one tooth 2176 on the invagination that above is the piston 2170, against which the top part 2174 is pushed by the bottom part 2172. The pliable and resilient part 2172, when not forced by a tube, seals the channel 2112 of from the chamber 2120; when forced by a tube, the force of the tube compresses the bottom part 2172, and thus marker fluid may enter the chamber 2120 via at least one gap 2178 between the piston 2170 and the invagination 2128. The bottom part may be made of a soft and resilient polymer such as a soft rubber, or sponge, and the top part of a hard material such as polycarbonate. In other embodiments, there may be no teeth 2176, and the absorbent material 2123 in the feeder shaft 2144 may include resilient material that urges the piston 2170 down and can be compressed by the piston when the piston 2170 is pushed by a tube upwards.

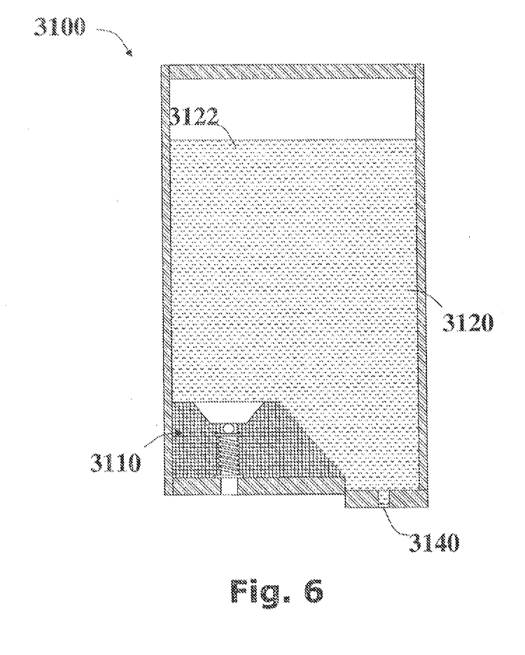

With particular reference to FIG. 6, a schematic representation is shown of a refillable cartridge 3100 for use in a computer printer. The 3100 has alternative embodiments of an ink-chamber 3120, an ink-applicator 3140 and a filling mechanism 3110. The ink-applicator 3140 of the ink 3100 is a print head having electronically operated nozzles such as is well known in the art.

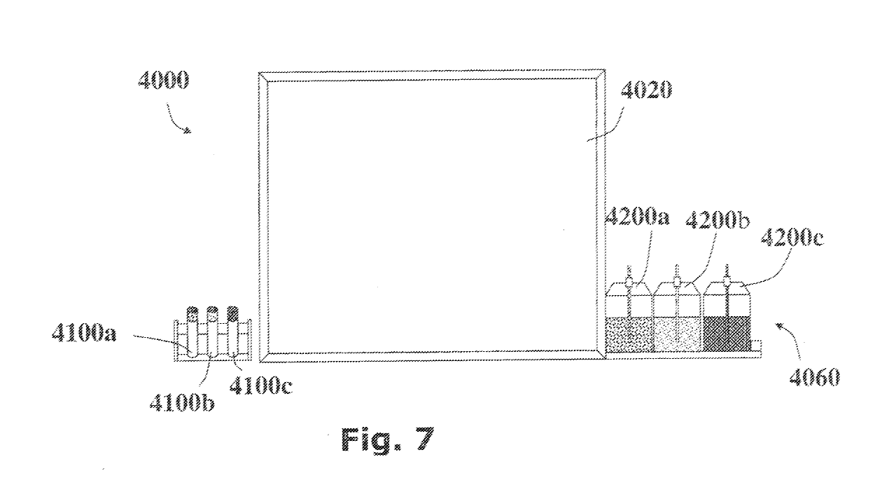

Referring now to FIG. 7, a particular embodiment of a refill system 4000 is presented in order to demonstrate one possible use of the refill systems disclosed herein. A schematic representation is shown of a presentation board 4020 such as is known in the art and are commonly used in schools, offices, lecture-halls and the like. A selection of refillable board-markers 4100a-c is provided for erasably marking the presentation board 4020.

It will be appreciated, that it is a known problem with board markers 4100a-c that they quickly run out of ink, making the writing on the board hard to read especially from a distance. All too often, a board marker which appears to be full of ink at the start of a presentation is unusable by the end of the same presentation.

Accordingly, a marker refilling station 4060 is provided in association with the presentation board 4020 having a selection of ink-fillers 4062a-c which may be used to refill the board markers 4020a-c efficiently and quickly during a presentation. The ink-fillers 4200a-c and the markers 4100a-c are preferably coded, such as colour-coded, to allow matching the markers and the fillers for using the appropriate marker-fluid.

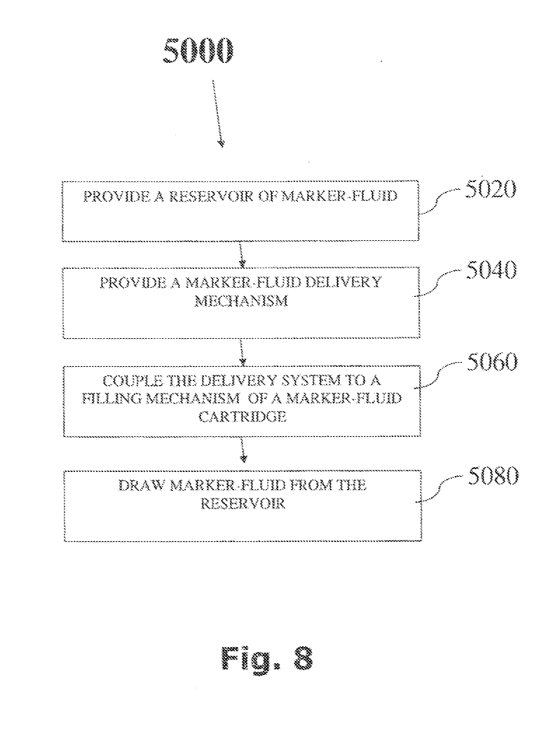

Reference is now made to the flowchart of FIG. 8, showing the main steps of a possible method 5000 for filling a marker-fluid cartridge. The method includes the following steps: step 5020—providing a filler of marker-fluid; step 5040—providing a marker-fluid delivery mechanism and coupling it to the filler to allow drawing marker fluid from the filler; step 5060—coupling with a delivery tube the delivery mechanism to a filling mechanism of a marker-fluid cartridge; and step 5080—drawing marker-fluid from the filler via the delivery mechanism into the marker-fluid cartridge.

Optionally step 5060 involves pushing a check valve associated with the filling mechanism against the delivery tube such that the check valve opens to receive the marker fluid, and step 5080 involves pumping the marker-fluid from the filler into the cartridge as disclosed hereinabove.

The scope of the present invention is defined by the appended claims and includes both combinations and sub combinations of the various features described hereinabove as well as variations and modifications thereof.

In the claims, the word “comprise”, and variations thereof such as “comprises”, “comprising” and the like indicate that the components listed are included, but not generally to the exclusion of other components.

1. Portable refillable marker-fluid cartridge comprising:
a marker-chamber therein;
a marker-fluid applicator extending from out of the cartridge wherein said marker fluid applicator is in fluid communication with the marker-chamber;
a filling mechanism configured to open from the delivery tube being pushed theretowards, thereby allowing the marker fluid to pass into the marker-chamber, and
at least one seal-ring configured to minimize leak of the marker-fluid out of the marker-chamber.

2.-6. (canceled)

7. The system cartridge according to claim 1, further comprising air-release means configured to allow expelling air from the marker-chamber during filling the marker-chamber with marker-fluid, and to not allow expelling of marker-fluid from the marker-chamber.

8. The system cartridge according to claim 1, wherein said marker-chamber comprising a marker-fluid absorbent fluidly communicable with both the filling mechanism and the applicator.

9. The system cartridge according to claim 8, wherein when the applicator of the cartridge is applied to a surface, thereby applying marker-fluid to the surface, the absorbent and the marker-fluid of the cartridge allow replacement of the marker-fluid in the applicator at a rate faster than the rate the marker-fluid is applied to the surface.

10. The system cartridge according to claim 1, further comprising a removable valve cap for the cartridge, configured to seal off the filling mechanism of the cartridge from air when the valve cap is fit onto the cartridge.

11-12. (canceled)

13. The cartridge according to claim 1, wherein the cartridge is selected from one or more of the group comprising: pens, paint brushes, whiteboard markers, permanent markers and inkjet cartridges, highlighters, laser printer toner cartridges and correction fluid cartridges.

14. (canceled)

15. The cartridge of claim 1, further comprising a wall having an invagination therein, wherein the filling mechanism is held in said invagination.

16. The cartridge according to claim 1, wherein, the filling mechanism comprises a holder with a channel passing therethrough, slideable and held with at least one seal-ring in the invagination.

17.-20. (canceled)

21. The cartridge according to claim 1, wherein the filling mechanism comprises a piston comprising a bottom pliable and resilient part and a top hard part permanently attached thereto, the top part being pushed up by the bottom part the pliable and resilient part, when not forced by a tube, sealing the chamber; when forced by a tube, the force of the tube compresses the bottom part whereby marker fluid may enter the chamber via at least one gap between the piston and the invagination.

22. The cartridge according to claim 21, wherein the invagination comprises at least one tooth to hold the piston wherein the top part is pushed up against the tooth.

23.-30. (canceled)

31. The cartridge according to claim 1, wherein said marker-fluid applicator is selected from a group consisting of: print heads, nibs, roller-balls, ball-points, felt-tips, fiber-tips, brushes, reeds, nozzles and combinations thereof.

32.-33. (canceled)

34. A system for filling marker-fluid filler comprising:
a) at least one marker-fluid filler comprising:
a reservoir;
a delivery tube through which the marker-fluid is dispensable, and
a pump configured to allow pumping said marker-fluid in said reservoir throughout the delivery tube, and
b) at least one portable refillable marker-fluid cartridge of claim 1.

35.-41. (canceled)

42. A method for filling a marker-fluid cartridge, the method comprising:
providing a filler of marker-fluid, the filler comprising:
a delivery tube through which the marker-fluid is dispensable, and
a pump;
providing a portable refillable marker-fluid cartridge comprising:
a marker-chamber therein; a filling mechanism, and a seal-ring, the filling mechanism configured to open from a delivery tube being pushed thereto, the seal-ring configured to minimize leak of the marker-fluid out of the marker-chamber;
coupling said delivery tube to the filling mechanism; and
drawing marker-fluid with said pump from said filler into said marker-chamber via said filling mechanism, while preventing release of marker-fluid from said marker-chamber.

43. The method according to claim 42, wherein, coupling said delivery tube to said filling mechanism and drawing said marker-fluid comprises: repeatedly pushing said delivery tube against the filling mechanism such that said filling mechanism opens to allow the marker-chamber to receive said marker fluid.

44. The system according to claim 34, further comprising at least one presentation board, wherein each filler is color-coded to match each cartridge.

45. The system according to claim 42, wherein the cartridge further comprises a wall having an invagination therein, wherein the filling mechanism is held in said invagination, the channel having an internal diameter adjacent to the wall comprising the invagination, the diameter allowing a close fit of the delivery tube therein.

46. The system according to claim 42, the filling mechanism further comprising a filling port leading from the bottom wall to the channel, wherein the filling port allows a close fit of the delivery tube therein.
